(19) United States
(12) Patent Application Publication
(10) Pub. No.: US 2012/0263220 A1
(43) Pub. Date: Oct. 18, 2012

(54) METHOD, DEVICE AND SYSTEM FOR CLOCK SYNCHRONIZATION

(75) Inventors: Bingbo Li, Shenzhen (CN); Long Jiang, Shenzhen (CN); Wenguang Xu, Shenzhen (CN); Wenhua Sun, Santa Clara, CA (US); Yuanxin Xu, Hangzhou (CN); Shumin Chen, Hangzhou (CN); Yang Wang, Hangzhou (CN); Yunfeng Liu, Hangzhou (CN)

(73) Assignees: Zhejiang University, Hangzhou (CN); Huawei Technologies Co., Ltd., Shenzhen (CN)

(21) Appl. No.: 13/532,101

(22) Filed: Jun. 25, 2012

Related U.S. Application Data
(63) Continuation of application No. PCT/CN2010/079645, filed on Dec. 10, 2010.

(30) Foreign Application Priority Data
Dec. 25, 2009 (CN) 200910265516.8

(51) Int. Cl. H04L 7/00; H04B 17/00

(52) U.S. Cl. 375/224; 375/354

(57) ABSTRACT

A method, a device and a system for clock synchronization are provided. The method includes: under a first transfer mode, generating a first receiving timestamp by using a first link, and acquiring a first transmitting timestamp of a master clock device; under a second transfer mode, generating a second transmitting timestamp by using the first link, and acquiring a second receiving timestamp of the master clock device; and acquiring a time difference to the master clock device according to the first receiving timestamp, the first transmitting timestamp, the second transmitting timestamp and the second receiving timestamp, and realizing a clock synchronization with the master clock device by using the time difference. A slave clock device and a master clock device are provided in the embodiments of the present invention, as well as a system for clock synchronization.

### CROSS-REFERENCE TO RELATED APPLICATION

This application is a continuation of International Application No. PCT/CN2010/079645, filed on Dec. 10, 2010, which claims priority to Chinese Patent Application No. 200910265516.8, filed on Dec. 25, 2009, both of which are hereby incorporated by reference in their entireties

### FIELD OF THE INVENTION

The present invention relates to the field of the communication technology, and particularly, to a method, a device and a system for clock synchronization.

### BACKGROUND OF THE INVENTION

With continuous development of the communication technology, the transmission technology of the telecommunication network has gradually evolved from the circuit switching mode based on Time Division Multiplex (TDM) to the packet switching mode based on IP. In the traditional TDM networking solution, the downlink node of an E1/T1 link can recover the synchronous signal of the uplink node from the E1/T1 link of the TDM. While in the IP networking solution, due to asynchronous transmission characteristics, the IP network does not support the transmission of the synchronous information of the physical layer. Thus during the evolution of the telecommunication network from the circuit switching mode to the packet switching mode, how to ensure the synchronization performance of the network is a problem to be urgently solved.

In the prior art, the ideal network synchronization solution is the Precision Time Synchronization Protocol IEEE 1588, which is widely used in the scene of symmetrical uplink and downlink time delays in the communication link, because it simultaneously transmits frequency information and phase information and achieves a high recovery precision of the synchronous information. In the prior art, when the master and slave clocks are to be synchronized, assuming that the uplink and downlink time delays are symmetrical to each other, then the timestamps of the master and slave clocks and the calculated average time delay are recorded to obtain the offset between the master and slave clocks, so as to synchronize the master and slave clocks.

The inventor finds that the prior art at least has the following problem: the network synchronization principle of the IEEE 1588 protocol is based on the assumption of symmetrical uplink and downlink time delays in the communication link, and cannot be applied to the scene of asymmetrical uplink and downlink time delays. However, in actual applications of the telecommunication network, the uplink and downlink time delays are asymmetrical to each other in many scenes, such as Asymmetrical Digital Subscriber Loop (ADSL) wired access technology, Worldwide Interoperability for Microware Access (WiMAX) wireless access technology, etc., wherein there may be the cases that the work modes such as modulation modes of the home terminal and the opposite terminal are asymmetrical to each other, or the distances of the physical links such as optical fibers of the round trip are not equal to each other, which cause the asymmetry of the uplink and downlink time delays in the communication link, and greatly decrease synchronization precision of the network synchronization solution in the prior art.

### SUMMARY OF THE INVENTION

The embodiments of the present invention provide a method, a device and a system for clock synchronization, so as to solve the application problem of the network synchronization solution under the scene of asymmetrical physical uplink and downlink in the prior art, realize a uniform link of the message round-trip between the master clock device and the slave clock device, ensure the symmetry of the uplink and downlink time delays, and improve the recovery precision of the synchronous information.

An embodiment of the invention provides a method for clock synchronization, comprising:

under a first transfer mode, generating a first receiving timestamp by using a first link, and acquiring a first transmitting timestamp of a master clock device;
under a second transfer mode, generating a second transmitting timestamp through the first link, and acquiring a second receiving timestamp of the master clock device; and acquiring a time difference to the master clock device according to the first receiving timestamp, the first transmitting timestamp, the second transmitting timestamp and the second receiving timestamp, and realizing a clock synchronization with the master clock device by using the time difference.

Further, an embodiment of the invention provides another method for clock synchronization, comprising:

under a first transfer mode, generating a first transmitting timestamp by using a first link, and transmitting the first transmitting timestamp to a slave clock device;
under a second transfer mode, generating a second receiving timestamp through the first link, and transmitting the second receiving timestamp to the slave clock device; and
by using the slave clock device, acquiring a time difference between the master clock device and the slave clock device according to the first transmitting timestamp and the second receiving timestamp as well as the first receiving timestamp and the second transmitting timestamp acquired by the slave clock device, and realizing a clock synchronization with the slave clock device.

An embodiment of the invention provides a slave clock device, comprising:

a first generation module configured to generate a first receiving timestamp by using a first link under a first transfer mode, and acquire a first transmitting timestamp of a master clock device;
a second generation module configured to generate a second transmitting timestamp through the first link under a second transfer mode, and acquire a second receiving timestamp of the master clock device; and
a first synchronization module configured to acquire a time difference to the master clock device according to the first receiving timestamp, the first transmitting timestamp, the second transmitting timestamp and the second receiving timestamp acquired by the first generation module and the second generation module, and realize a clock synchronization with the master clock device by using the time difference.

Further, an embodiment of the invention provides a master clock device, comprising:

a third generation module configured to generate a first transmitting timestamp by using a first link under a first transfer mode, and transmit the first transmitting timestamp to a slave clock device;
a fourth generation module configured to generate a second receiving timestamp through the first link under a second transfer mode, and transmit the second receiving timestamp to the slave clock device; and
a second synchronization module configured to acquire, through the slave clock device, a time difference between the master clock device and the slave clock device, according to the first transmitting timestamp and the second receiving timestamp as well as the first receiving timestamp and the second transmitting timestamp acquired by the slave clock device, and realize a clock synchronization with the slave clock device.

The embodiments of the invention provide a system for clock synchronization, comprising the slave clock device and the master clock device.

The embodiments of the invention provide a method, device and system for clock synchronization, wherein the first and second transfer modes are set. Under the first transfer mode, the slave clock device generates the first receiving timestamp under the first transfer mode through the first link, and acquires the first transmitting timestamp of the master clock device under the first transfer mode. Under the second transfer mode, the slave clock device generates the second transmitting timestamp under the second transfer mode through the first link, and acquires the second receiving timestamp of the master clock device under the second transfer mode. The slave clock device acquires the time difference to the master clock device according to the first receiving timestamp, the first transmitting timestamp, the second transmitting timestamp and the second receiving timestamp, synchronizes the slave clock in the slave clock device to the master clock in the master clock device according to the time difference, and realizes the clock synchronization with the master clock device. By setting the two transfer modes in this embodiment, the first link becomes the round-trip of the uplink and downlink two-way message of the master clock device and the slave clock device, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving the recovery precision of the synchronous information.

### BRIEF DESCRIPTION OF THE DRAWINGS

In order to more clearly describe the technical solutions of the embodiments of the present invention or the prior art, the drawings to be used in the descriptions of the embodiments or the prior art are briefly introduced as follows. Obviously, the following drawings just illustrate some embodiments of the present invention, and a person skilled in the art can obtain other drawings from these drawings without paying a creative effort.

FIG. 1 is a flowchart of a first embodiment of a method for clock synchronization according to the present invention;

FIG. 2 is a flowchart of a second embodiment of a method for clock synchronization according to the present invention;

FIG. 3 is a flowchart of a third embodiment of a method for clock synchronization according to the present invention;

FIG. 4 is a flowchart of a fourth embodiment of a method for clock synchronization according to the present invention;

FIG. 5A and FIG. 5B are flowcharts of a fifth embodiment of a method for clock synchronization according to the present invention;

FIG. 6 is a schematic diagram of a synchronization process in the fifth embodiment of the method for clock synchronization according to the present invention;

FIG. 7 is a schematic diagram of a first application scene in the fifth embodiment of the method for clock synchronization according to the present invention;

FIG. 8 is a schematic diagram of a second application scene in the fifth embodiment of the method for clock synchronization according to the present invention;

FIG. 9 is a structure diagram of a first embodiment of a slave clock device according to the present invention;

FIG. 10 is a structure diagram of a second embodiment of a slave clock device according to the present invention;

FIG. 11 is a structure diagram of a first embodiment of a master clock device according to the present invention;

FIG. 12 is a structure diagram of a second embodiment of a master clock device according to the present invention; and

FIG. 13 is a structure diagram of the hardware of an embodiment of a system for clock synchronization according to the present invention.

### DETAILED DESCRIPTION OF THE INVENTION

In order to make the object, technical solutions and advantages of the present invention be clearer, the technical solutions of the embodiments of the present invention will be clearly and completely described as follows in conjunction with the drawings. Obviously, the described embodiments are just a part of embodiments of the present invention rather than all the embodiments. Based on the embodiments of the present invention, any other embodiment obtained by a person skilled in the art without paying a creative effort shall fall within the protection scope of the present invention.

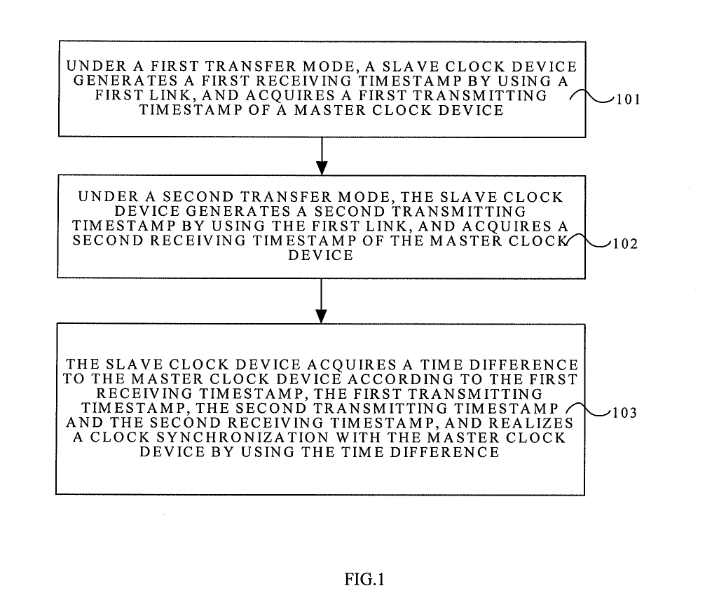

FIG. 1 is a flowchart of a first embodiment of a method for clock synchronization according to the present invention. As illustrated in FIG. 1, this embodiment provides a method for clock synchronization. The technical solution of this embodiment realizes a synchronization of a master clock in a master clock device and a slave clock in a slave clock device, and it is herein described at the side of the slave clock device. This embodiment may specifically include:

Step 101: under a first transfer mode, a slave clock device generates a first receiving timestamp by using a first link, and acquires a first transmitting timestamp of a master clock device.

In this step, the slave clock device generates the first receiving timestamp under the first transfer mode through the first link, and acquires the first transmitting timestamp of the master clock device under the first transfer mode.

Step 102: under a second transfer mode, the slave clock device generates a second transmitting timestamp, and acquires a second receiving timestamp of the master clock device through the first link.

In this step, the slave clock device generates the second transmitting timestamp under the second transfer mode, and acquires the second receiving timestamp of the master clock device under the second transfer mode still through the first link.

Step 103: the slave clock device acquires a time difference to the master clock device according to the first receiving timestamp, the first transmitting timestamp, the second transmitting timestamp and the second receiving timestamp, and realizes a clock synchronization with the master clock device by using the time difference.

In this step, after acquiring the time difference to the master clock device, the slave clock device synchronizes the slave clock therein to the master clock in the master clock device, and realizes the clock synchronization with the master clock device.

In this embodiment, the first transmitting timestamp is a timestamp at which the master clock device transmits a message to the slave clock device, and the first receiving timestamp is a timestamp at which the slave clock device receives the message transmitted by the master clock device. The second transmitting timestamp is a timestamp at which the slave clock device transmits a message to the master clock device, and the second receiving timestamp is a timestamp at which the master clock device receives the message transmitted by the slave clock device. In subsequent embodiments, the timestamps have the similar concepts to the timestamps herein, and will not be repeated. By the steps of this embodiment, synchronization of the slave clock in the slave clock device and the master clock in the master clock device is realized.

This embodiment provides a method for clock synchronization, wherein the first and second transfer modes are set. Under the first transfer mode, the slave clock device generates the first receiving timestamp under the first transfer mode, and acquires the first transmitting timestamp of the master clock device under the first transfer mode through the first link. Under the second transfer mode, the slave clock device generates the second transmitting timestamp under the second transfer mode, and acquires the second receiving timestamp of the master clock device under the second transfer mode through the first link. The slave clock device acquires the time difference to the master clock device according to the first receiving timestamp, the first transmitting timestamp, the second transmitting timestamp and the second receiving timestamp, synchronizes the slave clock in the slave clock device to the master clock in the master clock device according to the time difference, and realizes the clock synchronization with the master clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving recovery precision of the synchronous information.

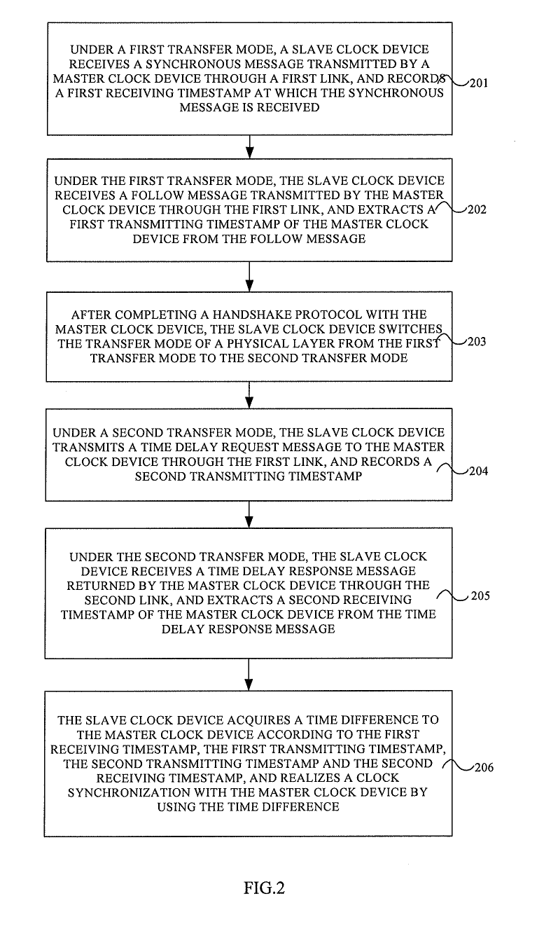

FIG. 2 is a flowchart of a second embodiment of a method for clock synchronization according to the present invention. As illustrated in FIG. 2, this embodiment provides a method for clock synchronization. On the basis of the first embodiment, the technical solution of this embodiment is still described at the side of the slave clock device. This embodiment may specifically include:

Step 201: under a first transfer mode, a slave clock device receives a synchronous message transmitted by a master clock device through a first link, and records a first receiving timestamp at which the synchronous message is received.

In this embodiment the first and second transfer modes are set. When a message is transmitted from the master clock device to the slave clock device under the first transfer mode, the master clock device transmits the message through the first link by using a Down Link Transmitting (DL Tx) module therein, and the slave clock device receives the message by using a Down Link Receiving (DL Rx) module therein. When a message is transmitted by the slave clock device to the master clock device under the first transfer mode, the slave clock device transmits the message through the second link by using an Up Link Transmitting (UL Tx) module therein, and the master clock device receives the message by using an Up Link Receiving (UL Rx) module therein. To be noted, the first and second links in this embodiment are set for distinguishing the links via which the communications between the master clock device and the slave clock device are made, wherein the first link may be an uplink, i.e., Link A introduced in subsequent embodiments, and the second link may be a downlink, i.e., Link B introduced in subsequent embodiments. Since the uplink and downlink are different from each other, the uplink and downlink time delays are also different from each other, i.e., the uplink and downlink time delays are asymmetrical to each other. When a message is transmitted from the master clock device to the slave clock device under the second transfer mode, the master clock device transmits the message by using a UL Tx module therein via the first link, and the slave clock device receives the message by using a UL Tx module therein. When a message is transmitted from the slave clock device to the master clock device, the slave clock device transmits the message by using a DL Tx module therein via the second link, and the master clock device receives the message by using a DL Rx module therein. In subsequent embodiments, the first transfer mode and the second transfer mode have the similar concepts to the transfer modes herein, and will not be repeated.

In this step, the master clock device and the slave clock device are both set under the first transfer mode. The DL Rx module in the slave clock device receives a synchronous message transmitted by the DL Tx module in the master clock device through the first link, and records the first receiving timestamp at which the slave clock device receives the synchronous message under the first transfer mode. The first receiving timestamp is assumed as TS1.

Step 202: under the first transfer mode, the slave clock device receives a follow message transmitted by the master clock device through the first link, and extracts a first transmitting timestamp of the master clock device from the follow message.

In this step, the master clock device and the slave clock device are still set under the first transfer mode. The DL Rx module in the slave clock device receives the follow message of the synchronous message transmitted by the DL Tx module in the master clock device via the first link. The follow message carries the first transmitting timestamp of the master clock device under the first transfer mode. The first transmitting timestamp is extracted by the slave clock device from the follow message and assumed as TM1. The time difference between the master clock in the master clock device and the slave clock in the slave clock device is assumed as Offset, and the downlink time delay caused by transmission of the synchronous message through the first link through from the master clock device to the slave clock device is assumed as DDL, then the following relation exists between the first receiving timestamp TS1 and the first transmitting timestamp TM1: TS1−TM1=DDL+Offset.

Step 203: after completing a handshake protocol with the master clock device, the slave clock device switches the transfer mode of a physical layer from the first transfer mode to the second transfer mode.

After the slave clock device receives the synchronous message and corresponding follow message transmitted by the master clock device, and acquires the first receiving timestamp TS1 of itself and the first transmitting timestamp TM1 of the master clock device, the handshake protocol is carried out between the slave clock device and the master clock device, so as to switch the transfer mode of the physical layer of the slave clock device from the first transfer mode to the second transfer mode, and also switch the transfer mode of the physical layer of the master clock device from the first transfer mode to the second transfer mode.

The handshake protocol between the master clock device and the slave clock device may be specifically completed as follows: the slave clock device transmits a switch request message to the master clock device through a second link, and receives a switch response message returned by the master clock device through the first link to realize the handshake protocol with the master clock device. Since the transfer modes of the physical layers of the master clock device and the slave clock device are not switched yet, the master clock device and the slave clock device are still under the first transfer mode. The UL Tx module in the slave clock device transmits the switch request message to the master clock device through the second link, and then the DL Rx module in the slave clock device receives the switch response message returned by the DL Tx module in the master clock device through the first link. Through interaction of the switch request message and the switch response message between the slave clock device and the master clock device, the handshake protocol between the slave clock device and the master clock device is realized, thereby switching the transfer modes of the physical layers of the slave clock device and the master clock device to the second transfer mode.

Step 204: under a second transfer mode, the slave clock device transmits a time delay request message to the master clock device through the first link, and records a second transmitting timestamp.

After the handshake protocol is completed, the transfer modes of the physical layers of the slave clock device and the master clock device are both switched to the second transfer mode. In this step, under the second transfer mode, the DL Tx module in the slave clock device transmits the time delay request message to the master clock device through the first link, and the slave clock device records the second transmitting timestamp at which the time delay request message is transmitted. The second transmitting timestamp is assumed as TS2.

Step 205: under the second transfer mode, the slave clock device receives a time delay response message returned by the master clock device through the second link, and extracts a second receiving timestamp of the master clock device from the time delay response message.

After the handshake protocol is completed, the transfer modes of the physical layers of the slave clock device and the master clock device are both switched to the second transfer mode. In this step, under the second transfer mode, after transmitting the time delay request message to the master clock device through the first link, the slave clock device receives the time delay response message returned by the UL Tx module in the master clock device. The time delay response message carries the second receiving timestamp at which the master clock device transmits the time delay response message. The second receiving timestamp is extracted from the time delay response message by the slave clock device and is assumed as TM2. Since the time difference between the master clock in the master clock device and the slave clock in the slave clock device is Offset, and the generated uplink time delay is DDL because the time delay request message transmitted by the slave clock device to the master clock device also passes through the first link, the following relation exists between the second transmitting timestamp TS2 and the second receiving timestamp TM2: TM2−TS2=DDL−Offset.

Step 206: the slave clock device acquires a time difference to the master clock device according to the first receiving timestamp, the first transmitting timestamp, the second transmitting timestamp and the second receiving timestamp, and realizes a clock synchronization with the master clock device by using the time difference.

After the slave clock device acquires the first receiving timestamp TS1, the first transmitting timestamp TM1, the second transmitting timestamp TS2 and the second receiving timestamp TM2, according to the following relations between the timestamps obtained through the above analysis, i.e., TS1−TM1=DDL+Offset and TM2−TS2=DDL−Offset, the formula of the time difference is generated: Offset=0.5(TS1−TM1+TS2−TM2). Thus the time difference Offset between the slave clock in the slave clock device and the master clock in the master clock device can be accurately calculated. According to the time difference Offset, the slave clock in the slave clock device is synchronized to the master clock in the master clock device, thereby realizing the synchronization of the master clock and the slave clock in network.

This embodiment provides a method for clock synchronization, wherein the first and second transfer modes are set. Under the first transfer mode, the slave clock device generates the first receiving timestamp under the first transfer mode, and acquires the first transmitting timestamp of the master clock device under the first transfer mode through the first link. Under the second transfer mode, the slave clock device generates the second transmitting timestamp under the second transfer mode, and acquires the second receiving timestamp of the master clock device under the second transfer mode through the first link. The slave clock device acquires the time difference to the master clock device according to the first receiving timestamp, the first transmitting timestamp, the second transmitting timestamp and the second receiving timestamp, synchronizes the slave clock in the slave clock device to the master clock in the master clock device according to the time difference, and realizes the clock synchronization with the master clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving recovery precision of the synchronous information.

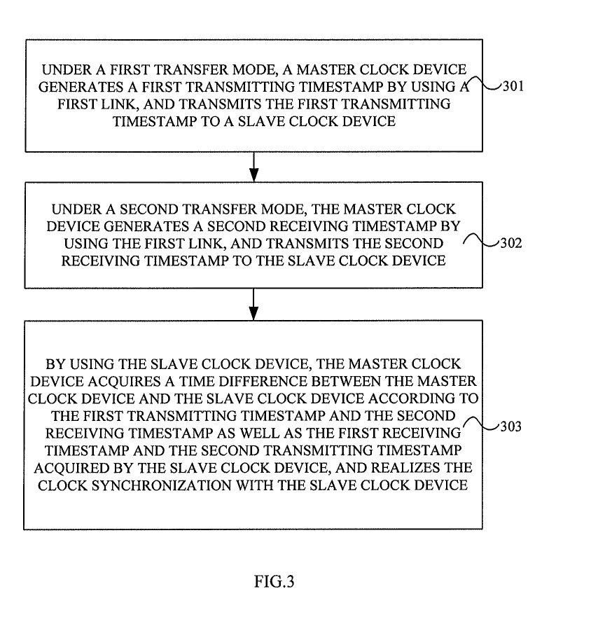

FIG. 3 is a flowchart of a third embodiment of a method for clock synchronization according to the present invention. As illustrated in FIG. 3, this embodiment provides a method for clock synchronization. The technical solution of this embodiment realizes the synchronization of the master clock in the master clock device and the slave clock in the slave clock device. This embodiment is corresponding to the first embodiment whose technical solution is described at the side of the slave clock device, while the technical solution of this embodiment is described at the side of the master clock device. This embodiment may specifically include:

Step 301: under a first transfer mode, a master clock device generates a first transmitting timestamp by using a first link, and transmits the first transmitting timestamp to a slave clock device. In this step, the master clock device generates the first transmitting timestamp under the first transfer mode by using the first link, and transmits the first transmitting timestamp to the slave clock device.

Step 302: under a second transfer mode, the master clock device generates a second receiving timestamp by using the first link, and transmits the second receiving timestamp to the slave clock device. In this step, the master clock device generates the second receiving timestamp under the second transfer mode still by using the first link, and transmits the second receiving timestamp to the slave clock device.

Step 303: by using the slave clock device, the master clock device acquires a time difference between the master clock device and the slave clock device according to the first transmitting timestamp and the second receiving timestamp as well as the first receiving timestamp and the second transmitting timestamp acquired by the slave clock device, and realizes the clock synchronization with the slave clock device. In this step, the time difference between the master clock device and the slave clock device is acquired through the slave clock device, and the slave clock in the slave clock device is synchronized to the master clock in the master clock device according to the time difference, so as to realize the clock synchronization of the two clock devices.

This embodiment provides a method for clock synchronization, wherein the first and second transfer modes are set. Under the first transfer mode, the master clock device generates the first transmitting timestamp under the first transfer mode, and transmits the first transmitting timestamp to the slave clock device through the first link. Under the second transfer mode, the master clock device generates the second receiving timestamp under the second transfer mode, and transmits the second receiving timestamp to the slave clock device through the first link. By using the slave clock device, the master clock device realizes the clock synchronization with the slave clock device, according to the first transmitting timestamp and the second receiving timestamp as well as the first receiving timestamp and the second transmitting timestamp acquired by the slave clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving recovery precision of the synchronous information.

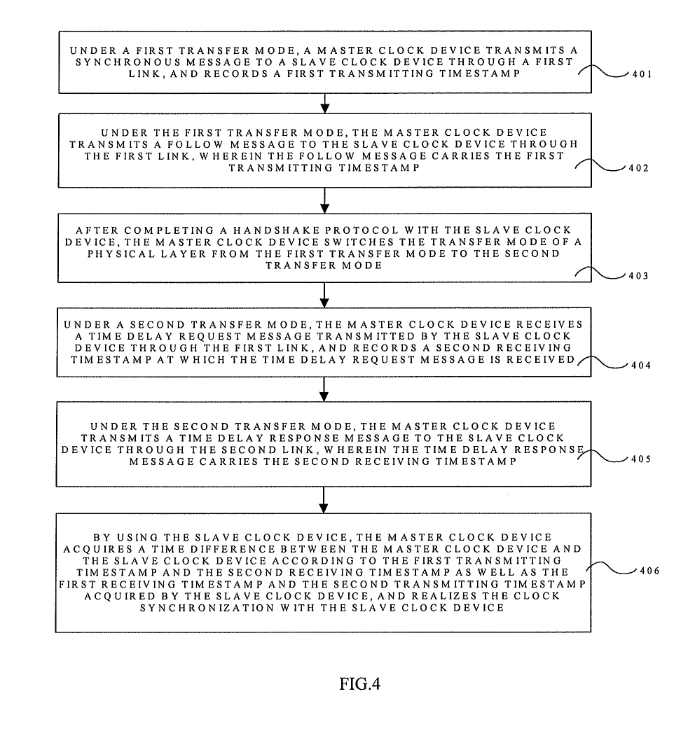

FIG. 4 is a flowchart of a fourth embodiment of a method for clock synchronization according to the present invention. As illustrated in FIG. 4, this embodiment provides a method for clock synchronization. On the basis of the third embodiment, the technical solution of this embodiment is still described at the side of the master clock device. This embodiment may specifically include:

Step 401: under a first transfer mode, a master clock device transmits a synchronous message to a slave clock device through a first link, and records a first transmitting timestamp.

In this step, the master clock device and the slave clock device are both set under the first transfer mode. The DL Tx module in the master clock device transmits the synchronous message to the slave clock device through the first link, and records the first transmitting timestamp TM1 at which the synchronous message is transmitted.

Step 402: under the first transfer mode, the master clock device transmits a follow message to the slave clock device through the first link, wherein the follow message carries the first transmitting timestamp.

In this step, the master clock device and the slave clock device are still set under the first transfer mode. After transmitting the synchronous message to the slave clock device, the DL Tx in the master clock device immediately transmits the follow message of the synchronous message to the slave clock device through the first link, wherein the follow message carries the first transmitting timestamp TM1 of the master clock device under the first transfer mode.

Step 403: after completing a handshake protocol with the slave clock device, the master clock device switches the transfer mode of a physical layer from the first transfer mode to the second transfer mode.

After the master clock device transmits the synchronous message and the corresponding follow message to the slave clock device, and transmits the first transmitting timestamp TM1 to the slave clock device, the handshake protocol is carried out between the master clock device and the slave clock device, so as to switch the transfer mode of the physical layer of the slave clock device from the first transfer mode to the second transfer mode, and also switch the transfer mode of the physical layer of the master clock device from the first transfer mode to the second transfer mode.

The handshake protocol between the master clock device and the slave clock device may be specifically completed as follows: the master clock device receives a switch request message transmitted by the slave clock device through the second link, and returns a switch response message to the slave clock device through the first link to realize the handshake protocol with the slave clock device. Since the transfer modes of the physical layers of the master clock device and the slave clock device are not switched yet, the master clock device and the slave clock device are still under the first transfer mode. The UL Rx module in the master clock device receives the switch request message transmitted by the UL Tx module in the slave clock device through the second link, and then the DL Tx module in the master clock device returns the switch response message to the DL Rx module in the slave clock device through the first link. Through interaction of the switch request message and the switch response message between the slave clock device and the master clock device, the handshake protocol between the slave clock device and the master clock device is realized, thereby switching the transfer modes of the physical layers of the slave clock device and the master clock device to the second transfer mode.

Step 404: under a second transfer mode, the master clock device receives a time delay request message transmitted by the slave clock device through the first link, and records a second receiving timestamp at which the time delay request message is received.

After the handshake protocol is completed, the transfer modes of the physical layers of the slave clock device and the master clock device are both switched to the second transfer mode. In this step, under the second transfer mode, the DL Rx module in the master clock device receives the time delay request message transmitted by the DL Tx module in the slave clock device through the first link, and the master clock device records the second receiving timestamp TM2 at which the time delay request message is received.

Step 405: under the second transfer mode, the master clock device transmits a time delay response message to the slave clock device through the second link, wherein the time delay response message carries the second receiving timestamp.

After the handshake protocol is completed, the transfer modes of the physical layers of the slave clock device and the master clock device are both switched to the second transfer mode. In this step, under the second transfer mode, after receiving the time delay request message transmitted by the slave clock device through the first link, the master clock device returns to the UL Rx module in the slave clock device the time delay response message, which carries the second receiving timestamp TM2 at which the master clock device receives the time delay response message.

Step 406: by using the slave clock device, acquires a time difference to the slave clock device according to the first transmitting timestamp and the second receiving timestamp as well as the first receiving timestamp and the second transmitting timestamp acquired by the slave clock device, and the master clock device realizes the clock synchronization with the slave clock device.

After the master clock device transmits the first transmitting timestamp TM1 and the second receiving timestamp TM2 to the slave clock device, according to the first transmitting timestamp TM1 and the second receiving timestamp TM2, as well as the acquired first receiving timestamp TS1 and second transmitting timestamp TS2, the slave clock device generates the formula of the time difference Offset=0.5 (TS1−TM1+TS2−TM2), based on the relations between the timestamps, i.e., TS1−TM1=DDL+Offset and TM2−TS2=DDL−Offset. Thus the time difference Offset between the slave clock in the slave clock device and the master clock in the master clock device can be accurately calculated. According to the time difference Offset, the slave clock in the slave clock device is synchronized to the master clock in the master clock device, thereby realizing the synchronization of the master clock and the slave clock in network.

This embodiment provides a method for clock synchronization, wherein the first and second transfer modes are set. Under the first transfer mode, the master clock device generates the first transmitting timestamp under the first transfer mode, and transmits the first transmitting timestamp to the slave clock device through the first link. Under the second transfer mode, the master clock device generates the second receiving timestamp under the second transfer mode, and transmits the second receiving timestamp to the slave clock device through the first link. By using the slave clock device, the master clock device realizes the clock synchronization with the slave clock device, according to the first transmitting timestamp and the second receiving timestamp as well as the first receiving timestamp and the second transmitting timestamp acquired by the slave clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving recovery precision of the synchronous information.

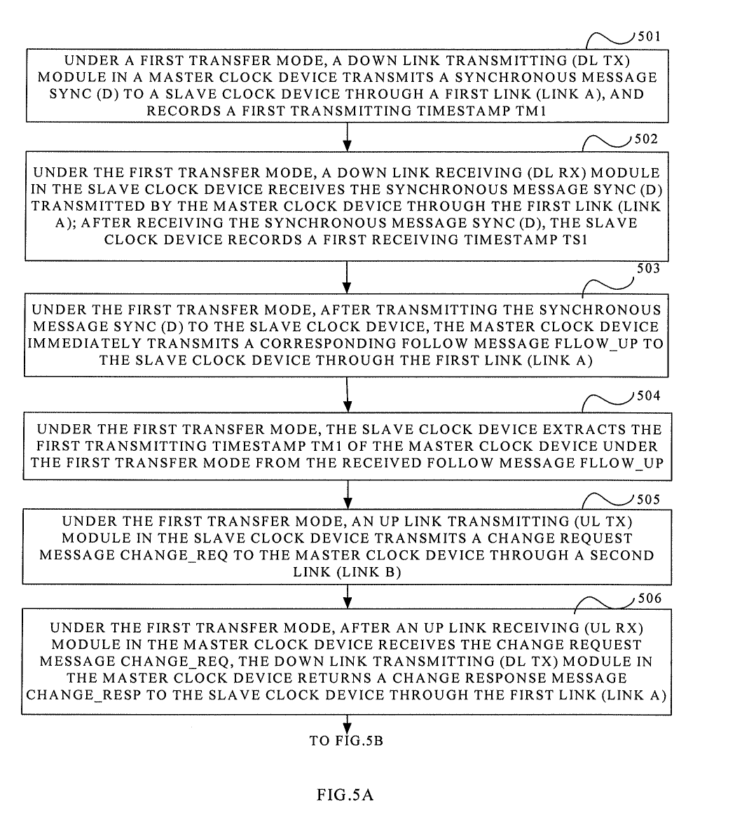

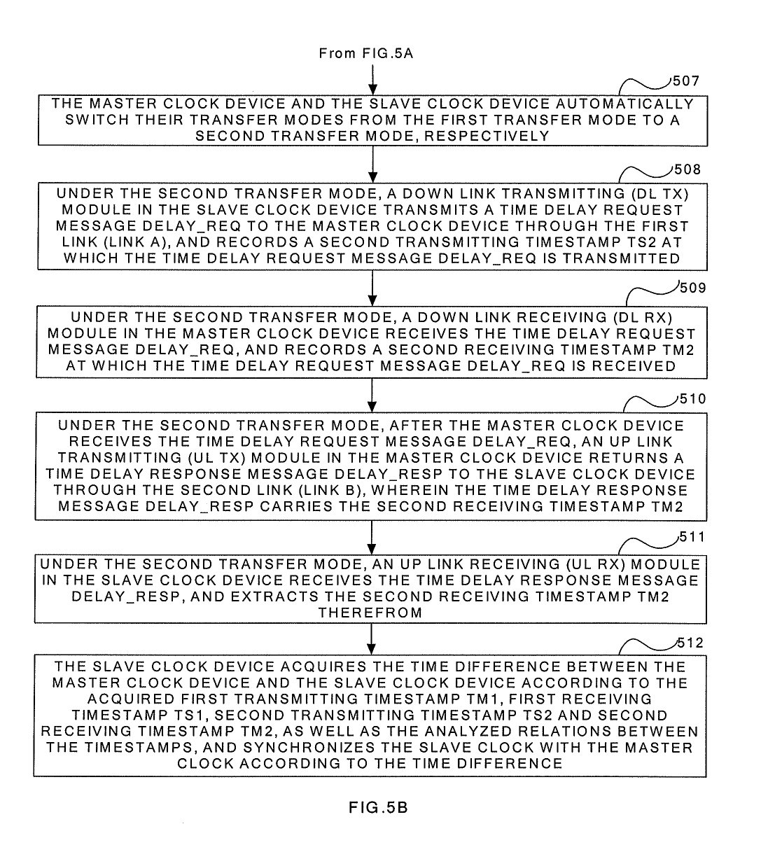

FIG. 5 (FIG. 5A and FIG. 5B) is a flowchart of a fifth embodiment of a method for clock synchronization according to the present invention. As illustrated in FIG. 5, this embodiment provides a method for clock synchronization, and the whole flow of the technical solution is detailedly described at the sides of both the master clock device and the slave clock device. FIG. 6 is a schematic diagram of a synchronization process in the fifth embodiment of the method for clock synchronization according to the present invention. This embodiment is described with reference to FIG. 6, and may specifically include:

Step 501: under a first transfer mode, a Down Link Transmitting (DL Tx) module in a master clock device transmits a synchronous message Sync (D) to a slave clock device through a first link (Link A), and records a first transmitting timestamp TM1.

Step 502: under the first transfer mode, a Down Link Receiving (DL Rx) module in the slave clock device receives the synchronous message Sync (D) transmitted by the master clock device through the first link (Link A); after receiving the synchronous message Sync (D), the slave clock device records a first receiving timestamp TS1.

Step 503: under the first transfer mode, after transmitting the synchronous message Sync (D) to the slave clock device, the master clock device immediately transmits a corresponding follow message Fllow_up to the slave clock device through the first link (Link A), wherein the follow message Fllow_up carries the first transmitting timestamp TM1 of the master clock device under the first transfer mode.

Step 504: under the first transfer mode, the slave clock device extracts the first transmitting timestamp TM1 of the master clock device under the first transfer mode from the received follow message Fllow_up.

As can be seen from FIG. 6, since the time difference between the master clock in the master clock device and the slave clock in the slave clock device is Offset, and the downlink time delay in the first link (Link A) through which the master clock device broadcasts the synchronous message Sync(D) to the slave clock device is DDL, the following relation exists between the first transmitting timestamp TM1 and the first receiving timestamp TS1: TS1−TM1=DDL+Offset.

Step 505: under the first transfer mode, an Up Link Transmitting (UL Tx) module in the slave clock device transmits a change request message Change_Req to the master clock device through a second link (Link B).

Step 506: under the first transfer mode, after an Up Link Receiving (UL Rx) module in the master clock device receives the change request message Change_Req, the Down Link Transmitting (DL Tx) module in the master clock device returns a change response message Change_Resp to the slave clock device through the first link (Link A).

Step 507: after a handshake protocol of the change request message Change_Req and the change response message Change_Resp is completed, the master clock device and the slave clock device automatically switch their transfer modes from the first transfer mode to a second transfer mode, respectively.

Step 508: under the second transfer mode, a Down Link Transmitting (DL Tx) module in the slave clock device transmits a time delay request message Delay_Req to the master clock device through the first link (Link A), and records a second transmitting timestamp TS2 at which the time delay request message Delay_Req is transmitted.

Step 509: under the second transfer mode, a Down Link Receiving (D L Rx) module in the master clock device receives the time delay request message Delay_Req, and records a second receiving timestamp TM2 at which the time delay request message Delay_Req is received.

Step 510: under the second transfer mode, after the master clock device receives the time delay request message Delay_Req, an Up Link Transmitting (UL Tx) module in the master clock device returns a time delay response message Delay_Resp to the slave clock device through the second link (Link B), wherein the time delay response message Delay_Resp carries the second receiving timestamp TM2.

Step 511: under the second transfer mode, an Up Link Receiving (UL Rx) module in the slave clock device receives the time delay response message Delay_Resp, and extracts the second receiving timestamp TM2 therefrom.

As can be seen from FIG. 6, since the time difference between the master clock in the master clock device and the slave clock in the slave clock device is Offset, and the uplink time delay is DDL because the time delay request message Delay_Req transmitted from the slave clock device to the master clock device also passes through the first link (Link A), the following relation exists between the second transmitting timestamp TS2 and the second receiving timestamp TM2: TM2−TS2=DDL−Offset.

Step 512: the slave clock device acquires the time difference between the master clock device and the slave clock device according to the acquired first transmitting timestamp TM1, first receiving timestamp TS1, second transmitting timestamp TS2 and second receiving timestamp TM2, as well as the analyzed relations between the timestamps (specifically the formula of the time difference is generated from above equations), i.e., calculates the time difference between the master clock device and the slave clock device according to the formula Offset=0.5(TS1−TM1+TS2−TM2), so as to acquire the time difference between the master clock in the master clock device and the slave clock in the slave clock device, and synchronize the slave clock with the master clock according to the time difference.

This embodiment provides a method for clock synchronization, wherein the first and second transfer modes are set. The master clock device broadcasts the synchronous message to the slave clock device through the first link, and the slave clock device transmits the time delay request message to the master clock device through the first link. The synchronization with the slave clock device is realized according to the acquired first transmitting timestamp and second receiving timestamp as well as the first receiving timestamp and the second transmitting timestamp acquired by the slave clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving the recovery precision of the synchronous information.

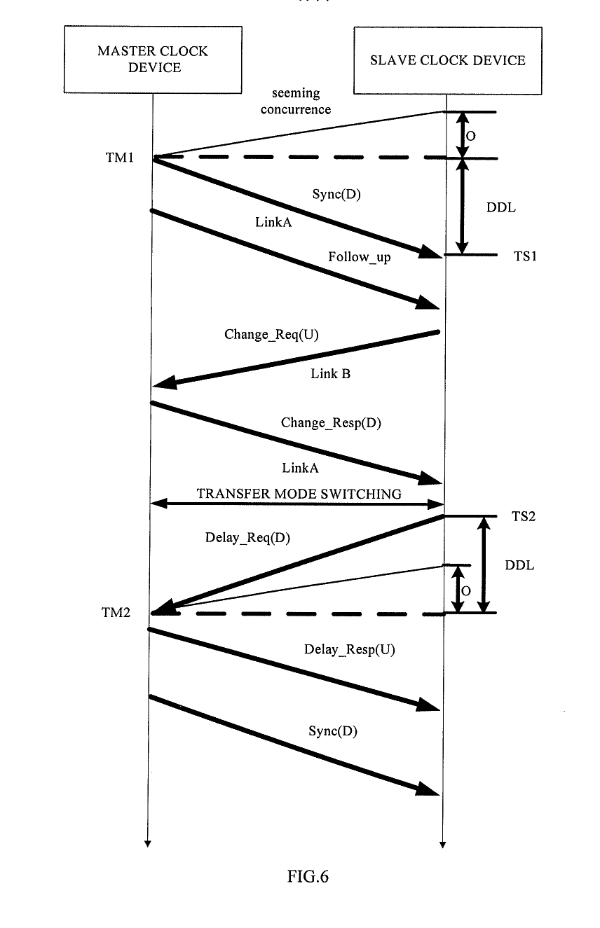

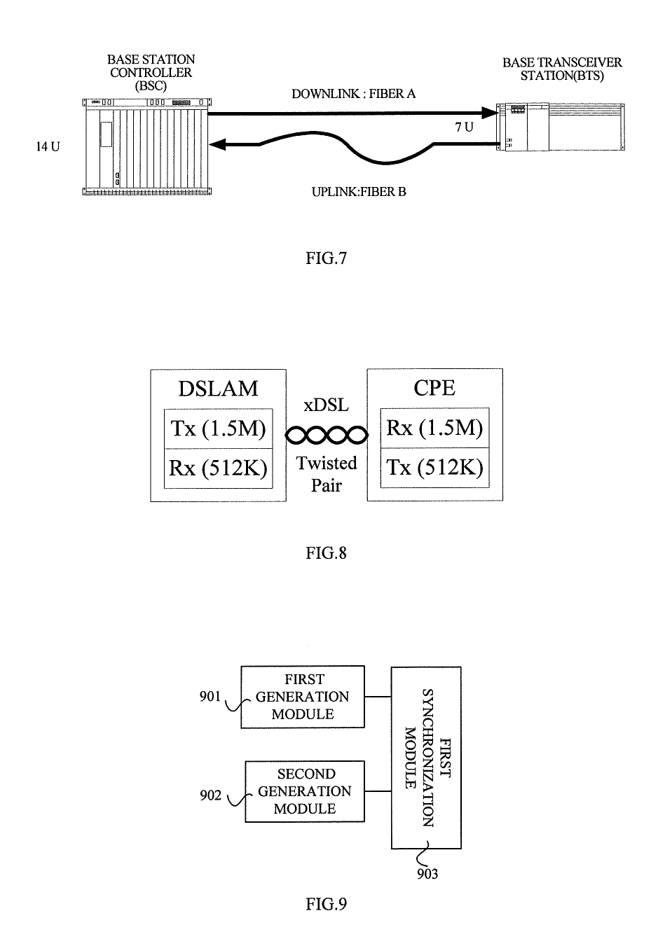

To be noted, the technical solutions of the first to fifth embodiments can be applied to the base station communication line of Base Station Controller (BSC)—Base Transceiver Station (BTS). FIG. 7 is a schematic diagram of a first application scene in the fifth embodiment of the method for clock synchronization according to the present invention. As can be seen from FIG. 7, since the optical fiber distances (Fiber A and Fiber B) of the going and return trips between the BSC and the BTS are not equal to each other, the uplink and downlink time delays are asymmetrical to each other, so the method of this embodiment can be used to overcome the defect of asymmetrical physical links and realize network synchronization. The technical solutions of the first to fifth embodiments can be also applied to the communication link of Customer Premise Equipment (CPE)—Digital Subscriber Line Access Multiplexer (CPE)—Digital Subscriber Line Access Multiplexer (DSLAM). FIG. 8 is a schematic diagram of a second application scene in the fifth embodiment of the method for clock synchronization according to the present invention. As can be seen from FIG. 8, since the work modes of the physical (PHY) layers in the DSLAM and the CPE are asymmetrical to each other, the uplink and downlink bandwidths between the DSLAM and the CPE are not equal to each other, thus the uplink and downlink time delays are asymmetrical to each other. In that case, the method of this embodiment can also be used to overcome the defect of asymmetrical physical links and realize network synchronization. The technical solutions of the first to fifth embodiments can be further applied to the communication link of wireless access, in which both the uplink and downlink work modes and the physical link distances are asymmetrical to each other, and the physical link distance in each communication is variable. In that case, the method of this embodiment can also be used to overcome the defect of asymmetrical physical links and realize network synchronization.

A person skilled in the art shall be appreciated that all or a part of steps for implementing the above method embodiments may be completed by instructing relevant hardware through a program that may be stored in a computer readable storage medium, and when being executed, the program performs the steps including the above method embodiments. The storage medium may include various mediums capable of storing program codes, such as ROM, RAM, magnetic disk and optical disk.

FIG. 9 is a structure diagram of a first embodiment of a slave clock device according to the present invention. As illustrated in FIG. 9, this embodiment provides a slave clock device which specifically performs each of the steps in the first method embodiment (omitted herein). The slave clock device provided by the embodiment specifically may include a first generation module 901, a second generation module 902, and a first synchronization module 903. In which, the first generation module 901 is configured to generate a first receiving timestamp by using a first link under a first transfer mode, and acquire a first transmitting timestamp of a master clock device. The second generation module 902 is configured to generate a second transmitting timestamp by using the first link under a second transfer mode, and acquire a second receiving timestamp of the master clock device. The first synchronization module 903 is configured to acquire a time difference to the master clock device according to the first receiving timestamp, the first transmitting timestamp, the second transmitting timestamp and the second receiving timestamp acquired by the first generation module 901 and the second generation module 902, and realize a clock synchronization with the master clock device by using the time difference.

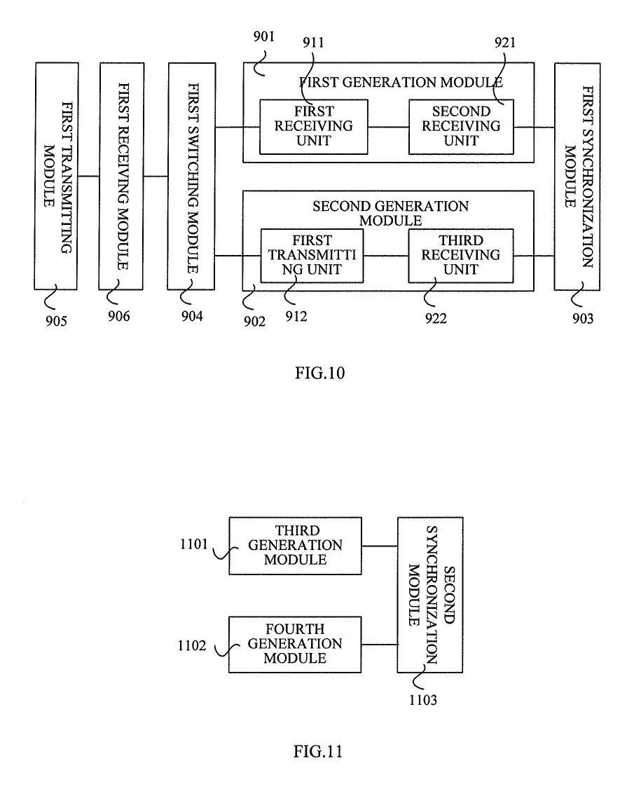

FIG. 10 is a structure diagram of a second embodiment of a slave clock device according to the present invention. As illustrated in FIG. 10, this embodiment provides a slave clock device which specifically performs each of the steps in the second method embodiment (omitted herein). On the basis of the first embodiment as illustrated in FIG. 9, the first synchronization module 903 of this embodiment may be specifically configured to calculate the time difference to the master clock device according to the following formula, and realize the clock synchronization with the master clock device by using the time difference:

Offset=0.5(TS1−TM1+TS2−TM2),

in which, Offset is the time difference, TS1 is the first receiving timestamp, TM1 is the first transmitting timestamp, TS2 is the second transmitting timestamp, and TM2 is the second receiving timestamp.

Further, the slave clock device may also include a first switching module 904 configured to switch the transfer mode of the physical layer from the first transfer mode to the second transfer mode, after a handshake protocol with the master clock device is completed. In which, the first switching module 904 specifically may be six 2-Channel switches through which the transfer mode is switched.

Further, the first generation module 901 may specifically include a first receiving unit 911 and a second receiving unit 921. In which, the first receiving unit 911 is configured to receive a synchronous message transmitted by the master clock device through the first link under the first transfer mode, and record the first receiving timestamp at which the synchronous message is received. The second receiving unit 921 is configured to receive a follow message transmitted by the master clock device through the first link under the first transfer mode, and extract the first transmitting timestamp of the master clock device from the follow message.

Further, the second generation module 902 may specifically include a first transmitting unit 912 and a third receiving unit 922. In which, the first transmitting unit 912 is configured to transmit a time delay request message to the master clock device through the first link under the second transfer mode, and record the second transmitting timestamp. The third receiving unit 922 is configured to receive a time delay response message returned by the master clock device through the second link under the second transfer mode, and extract the second receiving timestamp of the master clock device from the time delay response message.

Further, the slave clock device provided by this embodiment may also include a first transmitting module 905 and a first receiving module 906. In which, the first transmitting module 905 is configured to transmit a switch request message to the master clock device through the second link. The first receiving module 906 is configured to receive a switch response message returned by the master clock device through the first link to realize the handshake protocol with the master clock device.

This embodiment provides a slave clock device, wherein the first and second transfer modes are set. Under the first transfer mode, the slave clock device generates the first receiving timestamp under the first transfer mode, and acquires the first transmitting timestamp of the master clock device under the first transfer mode through the first link. Under the second transfer mode, the slave clock device generates the second transmitting timestamp under the second transfer mode, and acquires the second receiving timestamp of the master clock device under the second transfer mode through the first link. The slave clock device acquires the time difference to the master clock device according to the first receiving timestamp, the first transmitting timestamp, the second transmitting timestamp and the second receiving timestamp, synchronizes the slave clock in the slave clock device to the master clock in the master clock device, and realizes the clock synchronization with the master clock device. By setting the two transfer modes in this embodiment, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving the recovery precision of the synchronous information.

FIG. 11 is a structure diagram of a first embodiment of a master clock device according to the present invention. As illustrated in FIG. 11, this embodiment provides a master clock device which specifically performs each of the steps in the third method embodiment (omitted herein). The master clock device provided by this embodiment may specifically include a third generation module 1101, a fourth generation module 1102 and a second synchronization module 1103. In which, the third generation module 1101 is configured to generate a first transmitting timestamp by using a first link under a first transfer mode, and transmit the first transmitting timestamp to a slave clock device. The fourth generation module 1102 is configured to generate a second receiving timestamp through the first link under a second transfer mode, and transmit the second receiving timestamp to the slave clock device. The second synchronization module 1103 is configured to acquire, by using the slave clock device, a time difference between the master clock device and the slave clock device, according to the first transmitting timestamp and the second receiving timestamp as well as the first receiving timestamp and the second transmitting timestamp acquired by the slave clock device, and realize a clock synchronization with the slave clock device.

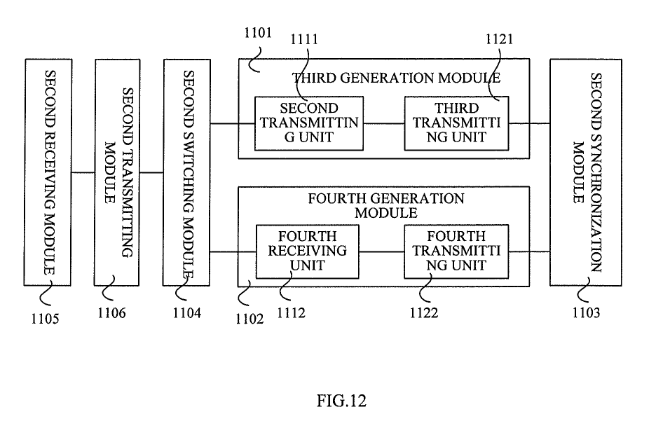

FIG. 12 is a structure diagram of a second embodiment of a master clock device according to the present invention. As illustrated in FIG. 12, this embodiment provides a master clock device which specifically performs each of the steps in the fourth method embodiment (omitted herein). On the basis of the first embodiment as illustrated in FIG. 12, the second synchronization module 1103 of this embodiment may be specifically configured to calculate, by using the slave clock device, the time difference between the master clock device and the slave clock device according to the following formula, and realize the clock synchronization with the master clock device:

Offset=0.5(TS1−TM1+TS2−TM2),

in which, Offset is the time difference, TS1 is the first receiving timestamp, TM1 is the first transmitting timestamp, TS2 is the second transmitting timestamp, and TM2 is the second receiving timestamp.

Further, the master clock device may also include a second switching module 1104 configured to switch the transfer mode of the physical layer from the first transfer mode to the second transfer mode, after a handshake protocol with the slave clock device is completed. In which, the second switching module 1104 specifically may be six 2-Channel switches through which the transfer mode is switched.

Further, the third generation module 1101 may specifically include a second transmitting unit 1111 and a third transmitting unit 1121. In which, the second transmitting unit 1111 is configured to transmit a synchronous message to the slave clock device through the first link under the first transfer mode, and record the first transmitting timestamp. The third transmitting unit 1121 is configured to transmit a follow message to the slave clock device through the first link under the first transfer mode, wherein the follow message carries the first transmitting timestamp.

Further, the fourth generation module 1102 may specifically include a fourth receiving unit 1112 and a fourth transmitting unit 1122. In which, the fourth receiving unit 1112 is configured to receive a time delay request message transmitted by the slave lock device through the first link under the second transfer mode, and record the second receiving timestamp at which the time delay request message is received. The fourth transmitting unit 1122 is configured to transmit a time delay response message to the slave clock device through the second link under the second transfer mode, wherein the time delay response message carries the second receiving timestamp.

Further, the master clock device provided by this embodiment may also include a second receiving module 1105 and a second transmitting module 1106. In which, the second receiving module 1105 is configured to receive a switch request message transmitted by the slave clock device through the second link. The second transmitting module 1106 is configured to return a switch response message to the slave clock device through the first link to realize the handshake protocol with the slave clock device.

This embodiment provides a master clock device, wherein the first and second transfer modes are set. Under the first transfer mode, the master clock device generates the first transmitting timestamp under the first transfer mode, and transmits the first transmitting timestamp to the slave clock device through the first link. Under the second transfer mode, the master clock device generates the second receiving timestamp under the second transfer mode, and transmits the second receiving timestamp to the slave clock device through the first link. By using the slave clock device, the master clock device realizes the clock synchronization with the slave clock device, according to the first transmitting timestamp and the second receiving timestamp as well as the first receiving timestamp and the second transmitting timestamp acquired by the slave clock device. By setting the two transfer modes in this embodiment, the uplink and downlink two-way message of the master clock device and the slave clock device is transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving recovery precision of the synchronous information.

This embodiment further provides a system for clock synchronization, including the slave clock device as illustrated in FIG. 9 or 10, and the master clock device as illustrated in FIG. 11 or 12.

This embodiment further provides another system for clock synchronization, including the Base Station Controller (BSC) and the Base Transceiver Station (BTS). The slave clock device as illustrated in FIG. 9 or 10 is provided in the BTS, the master clock device as illustrated in FIG. 11 or 12 is provided in the BSC, and the application scene is illustrated in FIG. 7.

This embodiment further provides another system for clock synchronization, including the user end equipment and the central office equipment. The slave clock device as illustrated in FIG. 9 or 10 is provided in the BTS, and the master clock device as illustrated in FIG. 11 or 12 is provided in the BSC. In which, the user end equipment specifically may be CPE, the central office equipment specifically may be DSLM, and the application scene is illustrated in FIG. 8.

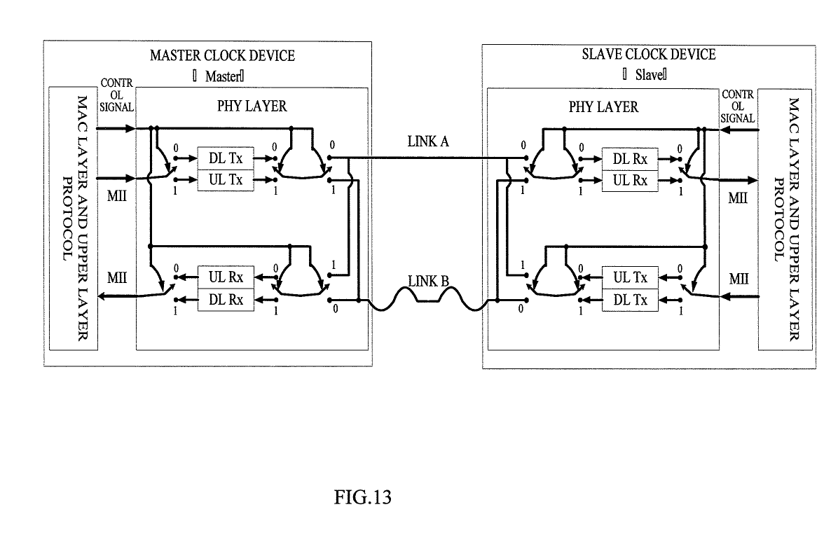

FIG. 13 is a structure diagram of the hardware of an embodiment of a system for clock synchronization according to the present invention. As illustrated in FIG. 13, this embodiment specifically provides a system for clock synchronization, including a master clock device and a slave clock device. In which, either of the master clock device and the slave clock device is provided with a PHY layer, a Media Access Control (MAC) layer and an upper layer protocol stack. The PHY layer of the master clock device includes a Down Link Transmitting (DL Tx) module, an Up Link Transmitting (UL Tx) module, an Up Link Receiving (UL Rx) module and a Down Link Receiving (DL Rx) module, as well as six 2-Channel switches which are uniformly controlled by the 1588 upper layer protocol stack in the master clock device and simultaneously select “0” or “1”. The PHY layer of the slave clock device includes a DL Tx module, a UL Rx module and a DL Rx module, as well as six 2-Channel switches which are uniformly controlled by the 1588 upper layer protocol stack in the slave clock device and simultaneously select “0” or “1”.

When the 2-Channel switches of the master clock device and the slave clock device all point to “0”, the transfer modes of the PHY layers of the master clock device and the slave clock device are both set as the first transfer mode. When the 2-Channel switches of the master clock device and the slave clock device all point to “1”, the transfer modes of the PHY layers of the master clock device and the slave clock device are both set as the second transfer mode. Under the first transfer mode, when transmitting a message to the slave clock device, the master clock device transmits the message by using the DL Tx module therein through the first link, and the slave clock device receives the message by using the DL Rx module therein. Under the first transfer mode, when transmitting a message to the master clock device, the slave clock device transmits the message by using the UL Tx module therein through the second link, and the master clock device receives the message through the UL Rx module therein. Under the second transfer mode, when transmitting a message to the slave clock device, the master clock device transmits the message by using the UL Tx module therein through the first link, and the slave clock device receives the message by using the UL Rx module therein. Under the second transfer mode, when transmitting a message to the master clock device, the slave clock device transmits the message by using the DL Tx module therein through the second link, and the master clock device receives the message through the DL Rx module therein.

This embodiment provides a system for clock synchronization. By setting the two transfer modes, the uplink and downlink two-way message of the master clock device and the slave clock device are transmitted on the first link, so that the uplink and downlink time delays are symmetrical to each other, thereby solving the application problem of the network synchronization solution under the scene of asymmetrical physical uplink and downlink in the prior art, realizing a uniform link of the message round-trip between the master clock device and the slave clock device, ensuring the symmetry of the uplink and downlink time delays, and improving the recovery precision of the synchronous information.

Finally to be noted, the above embodiments are just used for describing the technical solutions of the present invention, rather than making limitations thereto. Although the present invention is detailedly described with reference to the above embodiments, a person skilled in the art shall be appreciated that the technical solutions of the above embodiments can be modified, or some technical features therein can be equivalently replaced, without causing corresponding technical solutions to essentially deviate from the spirit and scope of the technical solution of each of the embodiments of the present invention.

What is claimed is:

1. A method for clock synchronization, comprising:
under a first transfer mode, generating a first receiving timestamp by using a first link, and acquiring a first transmitting timestamp of a master clock device;
under a second transfer mode, generating a second transmitting timestamp by using the first link, and acquiring a second receiving timestamp of the master clock device; and
acquiring a time difference to the master clock device according to the first receiving timestamp, the first transmitting timestamp, the second transmitting timestamp and the second receiving timestamp, and realizing a clock synchronization with the master clock device by using the time difference.

2. The method for clock synchronization according to claim 1, wherein acquiring the time difference to the master clock device according to the first receiving timestamp, the first transmitting timestamp, the second transmitting timestamp and the second receiving timestamp comprises:
calculating the time difference to the master clock device according to the formula:
Offset=0.5(TS1−TM1+TS2−TM2),
in which, Offset is the time difference, TS1 is the first receiving timestamp, TM1 is the first transmitting timestamp, TS2 is the second transmitting timestamp, and TM2 is the second receiving timestamp.

3. The method for clock synchronization according to claim 2, further comprising switching the transfer mode of a physical layer from the first transfer mode to the second transfer mode, after completing a handshake protocol with the master clock device;
under the first transfer mode, generating the first receiving timestamp by using the first link, and acquiring the first transmitting timestamp of the master clock device comprises:
under the first transfer mode, receiving a synchronous message transmitted by the master clock device through the first link, and recording the first receiving timestamp at which the synchronous message is received; and
under the first transfer mode, receiving a follow message transmitted by the master clock device through the first link, and extracting the first transmitting timestamp of the master clock device from the follow message.

4. The method for clock synchronization according to claim 3, wherein under the second transfer mode, generating the second transmitting timestamp by using the first link, and acquiring the second receiving timestamp of the master clock device comprises
under the second transfer mode, transmitting a time delay request message to the master clock device through the first link, and recording the second transmitting timestamp; and
under the second transfer mode, receiving a time delay response message returned by the master clock device through the second link, and extracting the second receiving timestamp of the master clock device from the time delay response message.

5. A method for clock synchronization, comprising:
under a first transfer mode, generating a first transmitting timestamp by using a first link, and transmitting the first transmitting timestamp to a slave clock device;
under a second transfer mode, generating a second receiving timestamp by using the first link, and transmitting the second receiving timestamp to the slave clock device; and
by using the slave clock device, acquiring a time difference between the master clock device and the slave clock device according to the first transmitting timestamp and the second receiving timestamp as well as the first receiving timestamp and the second transmitting timestamp acquired by the slave clock device, and realizing a clock synchronization with the slave clock device.

6. The method for clock synchronization according to claim 5, wherein acquiring the time difference between the master clock device and the slave clock device according to the first transmitting timestamp and the second receiving timestamp as well as the first receiving timestamp and the second transmitting timestamp acquired by the slave clock device, and realizing the clock synchronization with the slave clock device comprises:
realizing the clock synchronization with the slave clock device, according to the time difference between the master clock device and the slave clock device acquired from the formula:
Offset=0.5(TS1−TM1+TS2−TM2),
in which, Offset is the time difference, TS1 is the first receiving timestamp, TM1 is the first transmitting timestamp, TS2 is the second transmitting timestamp, and TM2 is the second receiving timestamp.

7. The method for clock synchronization according to claim 6, further comprising:
switching the transfer mode of a physical layer from the first transfer mode to the second transfer mode, after completing a handshake protocol with the slave clock device;
under the first transfer mode, generating the first transmitting timestamp by using the first link, and transmitting the first transmitting timestamp to the slave clock device comprises:
under the first transfer mode, transmitting a synchronous message to the slave clock device by using the first link, and recording the first transmitting timestamp; and
under the first transfer mode, transmitting a follow message to the slave clock device through the first link, wherein the follow message carries the first transmitting timestamp.

8. The method for clock synchronization according to claim 7, wherein under the second transfer mode, generating the second receiving timestamp by using the first link, and transmitting the second receiving timestamp to the slave clock device comprises:
under the second transfer mode, receiving a time delay request message transmitted by the slave clock device through the first link, and recording the second receiving timestamp at which the time delay request message is received; and
under the second transfer mode, transmitting a time delay response message to the slave clock device through the second link, wherein the time delay response message carries the second receiving timestamp.

9. A slave clock device, comprising:
a first generation module configured to generate a first receiving timestamp by using a first link under a first transfer mode, and acquire a first transmitting timestamp of a master clock device;
a second generation module configured to generate a second transmitting timestamp by using the first link under a second transfer mode, and acquire a second receiving timestamp of the master clock device; and
a first synchronization module configured to acquire a time difference to the master clock device according to the first receiving timestamp, the first transmitting timestamp, the second transmitting timestamp and the second receiving timestamp acquired by the first generation module and the second generation module, and realize a clock synchronization with the master clock device by using the time difference.

10. The slave clock device according to claim 9, wherein the first synchronization module is specifically configured to calculate the time difference to the master clock device according to the following formula, and realize the clock synchronization with the master clock device by using the time difference:
Offset=0.5(TS1−TM1+TS2−TM2),
in which, Offset is the time difference, TS1 is the first receiving timestamp, TM1 is the first transmitting timestamp, TS2 is the second transmitting timestamp, and TM2 is the second receiving timestamp.

11. The slave clock device according to claim 10, further comprising a first switching module configured to switch the transfer mode of a physical layer from the first transfer mode to the second transfer mode, after a handshake protocol with the master clock device is completed;
the first generation module comprises:
a first receiving unit configured to receive a synchronous message transmitted by the master clock device through the first link under the first transfer mode, and record the first receiving timestamp at which the synchronous message is received; and
a second receiving unit configured to receive a follow message transmitted by the master clock device through the first link under the first transfer mode, and extract the first transmitting timestamp of the master clock device from the follow message.

12. The slave clock device according to claim 11, wherein the second generation module comprises:
a first transmitting unit configured to transmit a time delay request message to the master clock device through the first link under the second transfer mode, and record the second transmitting timestamp; and
a third receiving unit configured to receive a time delay response message returned by the master clock device through the second link under the second transfer mode, and extract the second receiving timestamp of the master clock device from the time delay response message.

13. A master clock device, comprising:
a third generation module configured to generate a first transmitting timestamp by using a first link under a first transfer mode, and transmit the first transmitting timestamp to a slave clock device;
a fourth generation module configured to generate a second receiving timestamp by using the first link under a second transfer mode, and transmit the second receiving timestamp to the slave clock device; and
a second synchronization module configured to acquire, by using the slave clock device, a time difference between the master clock device and the slave clock device, according to the first transmitting timestamp and the second receiving timestamp as well as the first receiving timestamp and the second transmitting timestamp acquired by the slave clock device, and realize a clock synchronization with the slave clock device.

14. The master clock device according to claim 13, wherein the second synchronization module is specifically configured to realize, by using the slave clock device, the clock synchronization with the master clock device according to the time difference between the master clock device and the slave clock device acquired from the formula:
Offset=0.5(TS1−TM1+TS2−TM2),
In which, Offset is the time difference, TS1 is the first receiving timestamp, TM1 is the first transmitting timestamp, TS2 is the second transmitting timestamp, and TM2 is the second receiving timestamp.

15. The master clock device according to claim 14, further comprising a second switching module configured to switch the transfer mode of a physical layer from the first transfer mode to the second transfer mode, after a handshake protocol with the slave clock device is completed;
the third generation module comprises:
a second transmitting unit configured to transmit a synchronous message to the slave clock device through the first link under the first transfer mode, and record the first transmitting timestamp; and
a third transmitting unit configured to transmit a follow message to the slave clock device through the first link under the first transfer mode, wherein the follow message carries the first transmitting timestamp.

16. The master clock device according to claim 15, wherein the fourth generation module comprises:
a fourth receiving unit configured to receive a time delay request message transmitted by the slave lock device through the first link under the second transfer mode, and record the second receiving timestamp at which the time delay request message is received; and
a fourth transmitting unit configured to transmit a time delay response message to the slave clock device through the second link under the second transfer mode, wherein the time delay response message carries the second receiving timestamp.

17. A system for clock synchronization, comprising a slave clock device and a master clock device:
the slave clock device comprising:
a first generation module configured to generate a first receiving timestamp by using a first link under a first transfer mode, and acquire a first transmitting timestamp of a master clock device;
a second generation module configured to generate a second transmitting timestamp by using the first link under a second transfer mode, and acquire a second receiving timestamp of the master clock device; and
a first synchronization module configured to acquire a time difference to the master clock device according to the first receiving timestamp, the first transmitting timestamp, the second transmitting timestamp and the second receiving timestamp acquired by the first generation module and the second generation module, and realize a clock synchronization with the master clock device by using the time difference,
the master clock device comprising:
a third generation module configured to generate a first transmitting timestamp by using a first link under a first transfer mode, and transmit the first transmitting timestamp to a slave clock device;
a fourth generation module configured to generate a second receiving timestamp by using the first link under a second transfer mode, and transmit the second receiving timestamp to the slave clock device; and
a second synchronization module configured to acquire, by using the slave clock device, a time difference between the master clock device and the slave clock device, according to the first transmitting timestamp and the second receiving timestamp as well as the first receiving timestamp and the second transmitting timestamp acquired by the slave clock device, and realize a clock synchronization with the slave clock device.

18. The system according to claim 17, wherein
the first synchronization module is specifically configured to calculate the time difference to the master clock device according to the following formula, and realize the clock synchronization with the master clock device by using the time difference:
Offset=0.5(TS1−TM1+TS2−TM2),
in which, Offset is the time difference, TS1 is the first receiving timestamp, TM1 is the first transmitting timestamp, TS2 is the second transmitting timestamp, and TM2 is the second receiving timestamp,
the second synchronization module is specifically configured to realize, by using the slave clock device, the clock synchronization with the master clock device according to the time difference between the master clock device and the slave clock device acquired from the formula:
Offset=0.5(TS1−TM1+TS2−TM2).

19. The system according to claim 18, the slave clock device further comprising a first switching module configured to switch the transfer mode of a physical layer from the first transfer mode to the second transfer mode, after a handshake protocol with the master clock device is completed;
the first generation module comprises:
a first receiving unit configured to receive a synchronous message transmitted by the master clock device through the first link under the first transfer mode, and record the first receiving timestamp at which the synchronous message is received; and
a second receiving unit configured to receive a follow message transmitted by the master clock device through the first link under the first transfer mode, and extract the first transmitting timestamp of the master clock device from the follow message,
the master clock device further comprising a second switching module configured to switch the transfer mode of a physical layer from the first transfer mode to the second transfer mode, after a handshake protocol with the slave clock device is completed;
the third generation module comprises:
a second transmitting unit configured to transmit a synchronous message to the slave clock device through the first link under the first transfer mode, and record the first transmitting timestamp; and
a third transmitting unit configured to transmit a follow message to the slave clock device through the first link under the first transfer mode, wherein the follow message carries the first transmitting timestamp.

20. The system according to claim 19,
wherein the second generation module comprises:
a first transmitting unit configured to transmit a time delay request message to the master clock device through the first link under the second transfer mode, and record the second transmitting timestamp; and
a third receiving unit configured to receive a time delay response message returned by the master clock device through the second link under the second transfer mode, and extract the second receiving timestamp of the master clock device from the time delay response message;
and wherein the fourth generation module comprises:
a fourth receiving unit configured to receive a time delay request message transmitted by the slave lock device through the first link under the second transfer mode, and record the second receiving timestamp at which the time delay request message is received; and
a fourth transmitting unit configured to transmit a time delay response message to the slave clock device through the second link under the second transfer mode, wherein the time delay response message carries the second receiving timestamp.
